(19) United States
(12) Patent Application Publication
(10) Pub. No.: US 2024/0173924 A1
(43) Pub. Date: May 30, 2024

(54) SYSTEMS AND METHODS FOR ERROR REDUCTION IN THREE-DIMENSIONAL (3D) PRINTING

(71) Applicant: Florida State University Research Foundation, Inc., Tallahassee, FL (US)

(72) Inventors: Hui Wang, Tallahassee, FL (US); An-Tsun Wei, Tallahassee, FL (US)

(21) Appl. No.: 18/514,124

(22) Filed: Nov. 20, 2023

Related U.S. Application Data
(60) Provisional application No. 63/385,339, filed on Nov. 29, 2022.

(51) Int. Cl. B29C 64/393; B33Y 30/00; B33Y 50/02

(52) U.S. Cl. CPC B29C 64/393; B33Y 30/00; B33Y 50/02; B29C 64/118

(57) ABSTRACT

Systems and methods for error reduction in three-dimensional (3D) printing are provided and can include automatically adjusting printing parameters (for example, printing speed, acceleration, extrusion rate, and/or any other parameters) in the “G-codes” for a 3D printer (for example, fused deposition modeling) to compensate for printing errors that may occur when printing is performed at a high speed. An algorithm can be used to increase printing speed while mitigating reductions in printing quality.

### CROSS-REFERENCE TO RELATED APPLICATION

This application claims the benefit of U.S. Provisional Application Ser. No. 63/385,339, filed Nov. 29, 2022, the disclosure of which is hereby incorporated by reference in its entirety, including all figures, tables, and drawings.

### GOVERNMENT SUPPORT

This invention was made with government support under CMMI1901109 awarded by the National Science Foundation. The government has certain rights in the invention.

### BACKGROUND

Research on three-dimensional (3D) printing quality has focused on identifying the relationship between the process conditions and the overall quality of the final product. For example, prior studies are concerned almost entirely with geometric quality, such as the external contour of the printed structure. However, the quality of material filling in the structure is much less often addressed. The variation in the material filling patterns can significantly contribute to structural or surface defects such as overfill or that especially occur near the end segments of each printing line. These problems exhibit non-uniform distributions of filling materials on each layer and can potentially deteriorate the structural integrity and strength and affect the functional performance, thus inhibiting the widespread application.

Additionally, current commercial printers appear to be a black box for end users, who upload the computer model of part designs to printers and passively wait for results, having limited options for adjusting printers. All the intermediate steps, including printing path generation, path scanning scheme, and kinematic/dynamic control, are regulated by the manufacturer's proprietary technology and are inaccessible to the users. This situation does not allow users to further refine the process control to improve quality while meeting production demands.

### BRIEF SUMMARY

Embodiments of the subject invention provide novel and advantageous systems and methods for error reduction in three-dimensional (3D) printing. Systems and methods can include automatically adjusting printing parameters (for example, printing speed, acceleration, extrusion rate, and/or any other parameters) in the “G-codes” for a 3D printer (for example, fused deposition modeling) to compensate for printing errors that may occur when printing is performed at a high speed. An algorithm can be used to increase printing speed while mitigating reductions in printing quality, thereby improving printing productivity, especially when printing a large structure.

In an embodiment, a system for error reduction in 3D printing can comprise a processor and a machine-readable medium in operable communication with the processor and having instructions thereon that, when executed, perform the following steps: receiving printer data indicative of a 3D object to be printed by a 3D printer; identifying, based on the printer data, at least one printing defect area; and adjusting at least one printing parameter in the printer data to compensate for the at least one printing defect area. The at least one adjusted printing parameter can comprise printing speed of the 3D printer, extrusion rate of the 3D printer, and/or linewidth of the 3D printer. The printer data can be, for example, G-code data for the 3D printer. The identifying of the at least one printing defect area can comprise determining the at least one printing defect area based on where a gap between adjacent portions of a 3D printing path is greater than a threshold value. The instructions when executed can further perform the step of providing to the 3D printer the printer data with the at least one adjusted printing parameter. The printer data can comprise a G-code path of the 3D printer. The identifying of the at least one printing defect area can comprise detecting a location of non-uniformities (e.g., under-extrusion, over-extrusion, and/or one or more gaps between adjacent printing lines). The adjusting of the at least one printing parameter to compensate for the at least one printing defect area can comprise adjusting kinematics of an extruder of the 3D printer in the G-code path to compensate for the non-uniformities. The instructions when executed can further perform the step of evaluating a quality and time of printing that was performed by the 3D printer based on the printer data with the at least one adjusted printing parameter. The system can further comprise the 3D printer (e.g., in operable communication with, and/or comprising, the processor and/or the machine-readable medium) and/or a display (e.g., in operable communication with the processor, the machine-readable medium, and/or the 3D printer, and on which results of the adjusting and/or the printing can be displayed. The adjusting of the at least one printing parameter in the printer data to compensate for the at least one printing defect area can significantly improve the 3D printer, as discussed herein.

In another embodiment, a method for error reduction in 3D printing can comprise: receiving (e.g., by a processor in operable communication with the 3D printer) printer data indicative of a 3D object to be printed by a 3D printer; identifying (e.g., by the processor), based on the printer data, at least one printing defect area; and adjusting (e.g., by the processor) at least one printing parameter in the printer data to compensate for the at least one printing defect area. The at least one adjusted printing parameter can comprise printing speed of the 3D printer, extrusion rate of the 3D printer, and/or linewidth of the 3D printer. The printer data can be, for example, G-code data for the 3D printer. The identifying of the at least one printing defect area can comprise determining the at least one printing defect area based on where a gap between adjacent portions of a 3D printing path is greater than a threshold value. The method can further comprise providing (e.g., by the processor) to the 3D printer the printer data with the at least one adjusted printing parameter. The printer data can comprise a G-code path of the 3D printer. The identifying of the at least one printing defect area can comprise detecting a location of non-uniformities (e.g., under-extrusion, over-extrusion, and/or one or more gaps between adjacent printing lines). The adjusting of the at least one printing parameter to compensate for the at least one printing defect area can comprise adjusting kinematics of an extruder of the 3D printer in the G-code path to compensate for the non-uniformities. The method can further comprise evaluating (e.g., by the processor and/or by a user of the 3D printer) a quality and time of printing that was performed by the 3D printer based on the printer data with the at least one adjusted printing parameter. The method can further comprise providing to a display (e.g., in operable communication with the processor and/or the 3D printer) results of the adjusting and/or the printing.

### BRIEF DESCRIPTION OF THE DRAWINGS

FIG. 1(a) shows images of kinematics-induced quality problems (under-fill in the left image and over-fill in the right image).

FIG. 1(b) shows an example of printing errors at the start and stop end of printed lines.

FIG. 2 shows an example transfer learning process from a data-rich printer to a similar printer with limited data, according to an embodiment of the subject invention.

FIG. 3(a) shows a plot of width (in millimeters (mm)) versus length (L; in mm), showing width change with length.

FIG. 3(b) shows a plot of feed (in millimeters per second (mm/s)) versus L (in mm), showing feed change with length.

FIG. 3(c) shows a plot of width (in mm) versus time (T; in seconds (s)), showing width change with time.

FIG. 3(d) shows a plot of feed (in mm/s) versus T (in s), showing feed change with time.

FIG. 4 shows plots of feed (in mm/s) versus T (in s) (top plot) and width (in mm) versus T (in s) (bottom plot), showing five phases of straight-line printing.

FIG. 5 shows a plot of breakpoint1 (bp1; in s) versus acceleration (in millimeters per second squared (mm/s²).

FIGS. 6(a) and 6(b) show plots of width (in mm) versus T (in s), showing predicted width versus measurement values at varying speeds.

FIG. 7(a) shows an example estimated single-printed line, according to an embodiment of the subject invention.

FIG. 7(b) shows example estimated multiple printed lines, according to an embodiment of the subject invention.

FIGS. 8(a) and 8(b) shows plots of printed linewidth (in mm) versus T (in s) from a target printer.

FIGS. 9(a) and 9(b) show images of a three-dimensional (3D)-printed objects based on different parameter settings.

FIG. 10 shows an example conventional 3D printing process.

FIG. 11 (together with FIG. 12) shows an example method for analyzing a G-code path to identify inconsistencies, according to an embodiment of the subject invention.

FIG. 12 (together with FIG. 11) shows an example method for analyzing a G-code path to identify inconsistencies, according to an embodiment of the subject invention

FIG. 13 shows an example of a G-code compensation process, according to an embodiment of the subject invention.

FIG. 14 shows an example comparison between a 3D printed object without using G-code compensation versus a 3D printed object using G-code compensation, according to an embodiment of the subject invention.

FIG. 15 shows an example of quality increases in a 3D printed object based on increases in printing time, according to an embodiment of the subject invention.

FIG. 16 shows an example wavelet analysis.

FIG. 17 shows an example wavelet analysis.

FIG. 18 shows a block diagram of a computing system for error reduction in 3D printing, according to an embodiment of the subject invention.

FIG. 19 shows a schematic view of interconnected printers over the cloud, according to an embodiment of the subject invention.

FIG. 20 shows a schematic view of air gaps on a 3D printed object.

FIG. 21 shows a comparison of printing with and without local G-code compensation.

FIG. 22(a) shows an image of a 3D printed object with overall G-code adjustment. The printing time was 11 minutes and 37 seconds, with an overall speed of 25 square millimeters per second (mm²/s). The inner k (air gap) was 75 square millimeters (mm²), and the outer k was 25 mm².

FIG. 22(b) shows an image of a 3D printed object with G-code compensation strategy. The printing time was 7 minutes and 56 seconds, with an overall speed of 25 mm²/s. The inner k (air gap) was 75 square millimeters (mm²), and the outer k was 25 mm².

FIG. 23(a) shows an image of non-uniformity on a two-dimensional (2D) printing part.

FIG. 23(b) shows an image segmentation using Matlab on the part in FIG. 23(a). The image segmentation shows over-extrusion and void areas.

FIG. 24 shows a schematic view of a system and a process flow for error reduction in 3D printing, according to an embodiment of the subject invention.

FIG. 25 shows a schematic view of a system for error reduction in 3D printing, according to an embodiment of the subject invention.

FIG. 26 shows a schematic view of a cloud-based platform, according to an embodiment of the subject invention.

FIG. 27 shows a table of printing experimental results with different combinations of feed and acceleration.

FIG. 28 shows a table of prediction root mean square errors (RMSEs) for the experiments detailed in FIG. 27.

### DETAILED DESCRIPTION

Embodiments of the subject invention provide novel and advantageous systems and methods for error reduction in three-dimensional (3D) printing. Systems and methods can include automatically adjusting printing parameters (for example, printing speed, acceleration, extrusion rate, and/or any other parameters) in the “G-codes” for a 3D printer (for example, fused deposition modeling) to compensate for printing errors that may occur when printing is performed at a high speed. An algorithm can be used to increase printing speed while mitigating reductions in printing quality, thereby improving printing productivity, especially when printing a large structure.

The non-uniformity in the material distribution that causes infill defects may be attributed to the variations at two ends of a printing line deposited onto each layer. The printing line is the building block of the entire structure made by extrusion-based additive manufacturing (AM). When multiple printing lines are deposited side-by-side to create the infill pattern, the filling defects may be induced by such geometric variations in the printing lines. The infill defects are particularly evident when the infill lines reach the shape boundary, where each infill line stops or starts. The dimensional accuracy of a single-printing path affects more sophisticated 3D printing quality control. The variations in the printing line geometry are mostly caused by extruder kinematics, including printing speed, acceleration, and deceleration. The kinematics can impact the material deposition amount and the width of each printing line as the extruder moves along the printing path. Such infill defects can be more significant in the application of collaborative printing systems, by which multiple printers' extrudes co-create the same structure since more accelerate-decelerate kinematic cycles are involved.

Conventional methods adjust computer design models to compensate for the form shrinkages of external shapes. However, these existing methods only focus on the accuracy of geometries. These existing methods do not address infill errors and internal defects inside structures that may impact the functional performance of printed parts.

Embodiments of the subject invention can adjust the 3D printer's kinematic parameters over different areas (i.e., non-constant parameters) to compensate for the printing infill errors near areas where printing infill errors are likely to occur. Conventionally, these printing parameters are set at a fixed value before printing. However, the constant printing parameters may lead to more printing infill errors and internal defects when the printer is set at a high speed. Slowing the printing speed can significantly reduce printing errors but may fail to meet productivity requirements.

Systems and methods of embodiments of the subject invention can include any or all of the following functional parts: (1) an input/output (I/O) interface that can extract printing parameters and paths from printers and output G-code adjustment to printers; (2) a computing algorithm to estimate where printing anomalies may occur at high printing speed and how much adjustment of printing parameters is necessary near the predicted area; (3) an image processing function to evaluate and detect the occurrence of printing defects/anomalies; and (4) a calibration function that can fine-tune the printing parameters based on the evaluation of printing quality from images.

Systems and methods of embodiments of the subject invention can be used, for example, by individuals, labs, and manufacturers that provide printing services (e.g., creating molds, personal protection gears (PPE), etc.) to improve their productivity. In addition, healthcare providers that own 3D printers can also benefit from because they can quickly produce necessary components for medical devices (e.g., implants customized for a patient's particular anatomy).

For material-extrusion-based AM, a G-code may be used to control the movement of the nozzle (for example, extruder or liquefier head) of the 3D printer, including jerk, acceleration, feed, and/or any other types of movement. The nozzle may be the component of the 3D printer from which the material comprising the 3D printed object is extruded. For example, the G-code may provide a series of instructions that provide an indication to the 3D printer as to the specific pattern in which the nozzle should be moved to print the 3D object.

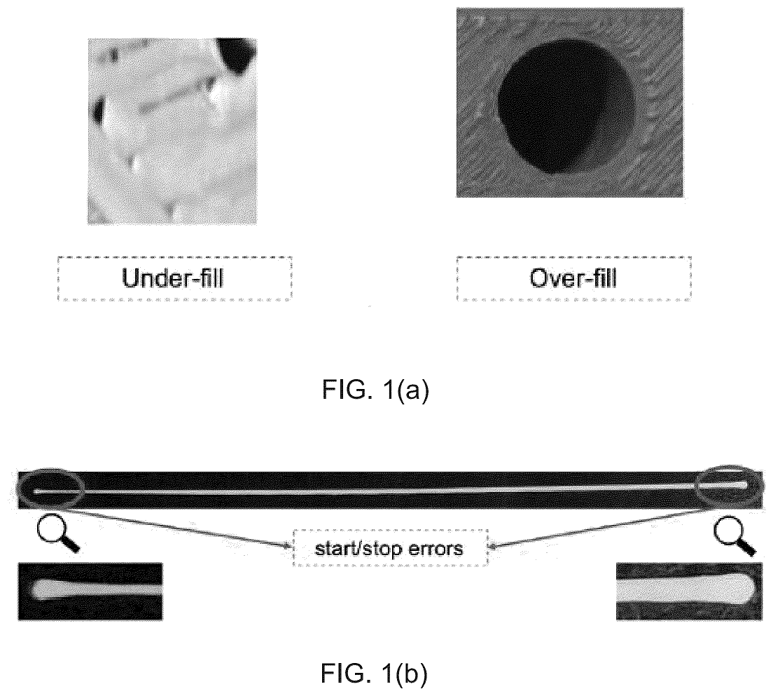

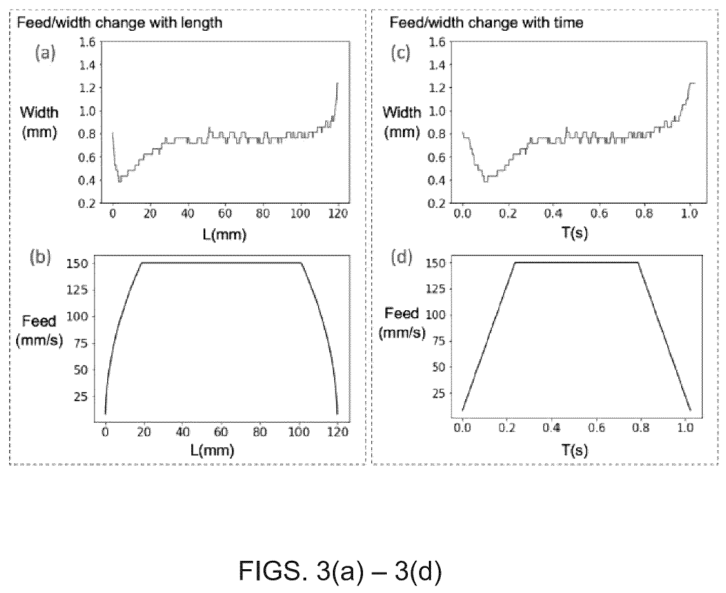

FIGS. 1(a) and 1(b) show results of straight-line printing with certain acceleration and feed specified in the G-code. As illustrated in FIGS. 1(a) and 1(b), the start and/or stop errors are clear. Linewidth measurements are shown in FIG. 3(a). FIG. 3(b) shows that the linewidth is closely related to the kinematic status of the nozzle head. Therefore, a model characterizing the relationship between the linewidth and the kinematic parameters (for example, feed, acceleration, jerk, and/or any other parameters) may be employed. For the simplicity of the model's architecture, the printing linewidth versus printing length and feed versus printing length may be converted to printing linewidth versus printing time and feed versus printing time, respectively. In FIGS. 3(a)-3(d), the linewidth and feed speed are plotted against both printing length (FIGS. 3(a) and 3(b)) and nominal printing time (FIGS. 3(c) and 3(d)). The printing time in FIGS. 3(a)-3(d) may be the nominal time that may be calculated based on the printing length, jerk, and/or nominal acceleration. The time may be based on the nominal feed that is specified in the G-code. However, in the real printing process, the real-time acceleration and feed may have a certain amount of deviations compared with the nominal values specified in the G-code. By considering such deviations, the real acceleration and feed used in the model may be assumed to be within a pre-specified range as follows:

a=rₐa₀

F=r_{F}F₀

0.9≤rₐ≤1.1

0.9≤r_{F}≤1.1 (1)

where a is the actual acceleration, F is the real target feed speed, a₀ is the nominal acceleration, F₀ is the nominal target feed speed, and rₐ and r_{F} are scaling factors that decide the deviations between real values and specified nominal values. The deviations may be caused by the printer's internal system errors and material properties. The values of rₐ and r_{F} may be determined via exhaustive grid research. Based on the engineering knowledge and experience, the deviations usually cannot exceed 10% of nominal target values for the printer with good quality. Therefore, the two parameters may be set in the range of 0.9-1.1 for the printer's kinematics. It should be noted that setting a range for these parameters is optional, and the purpose is to narrow the search space to improve the search efficiency. If the quality of the 3D printers is poor, the range can also be set wider, which may slow the search for prediction model parameters.

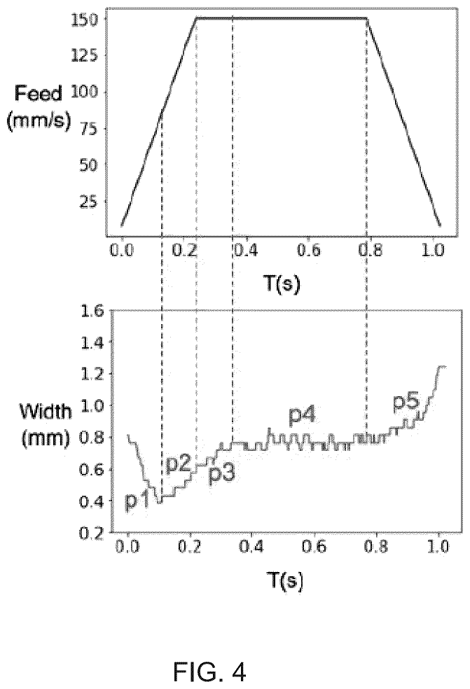

By considering that the movement of the printing nozzle may include three phases (for example, an accelerating phase, a constant speed phase, and a decelerating phase), a piecewise model may be used to characterize the effect of kinematic parameters on printing line quality based on the relationship of linewidth and printing speed (examples shown in FIGS. 3(a)-3(d) and FIG. 4). For a straight-line printing process, five phases (segmentations) may be partitioned as follows (see also FIG. 4).
(1) Phase 1 (p1, Pre-Action Phase): The nozzle begins moving, and the linewidth decreases.
(2) Phase 2 (p2, Warm-Up Phase I): The nozzle continues accelerating, and the linewidth starts to increase.
(3) Phase 3 (p3, Warm-Up Phase II): The nozzle reaches specified feed, and the linewidth keeps increasing.
(4) Phase 4 (p4, Steady Phase): The linewidth reaches nominal width and remains constant, and the nozzle remains constant speed.
(5) Phase 5 (p5, Slow-Down Phase): The nozzle starts to decelerate, and the printing linewidth starts to increase.

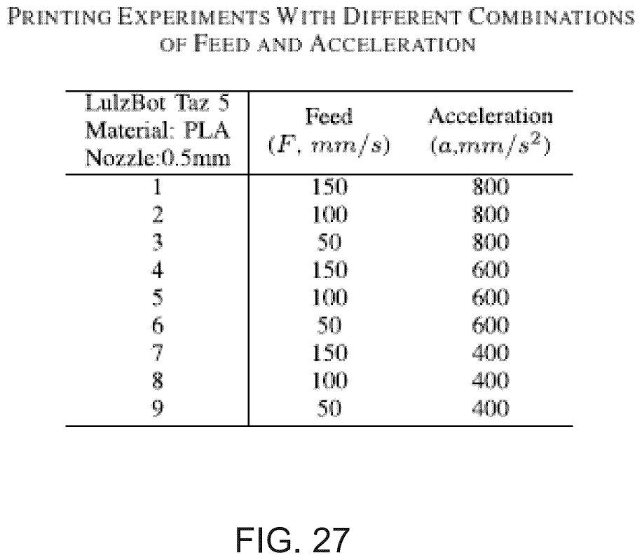

The above partitioning separates the warm-up phase into two phases because the time when the printing feed (speed) first reaches its steady state may be ahead of the time when the printing linewidth first reaches a steady state. The breakpoints of the above phases are important for model formulation. To decide the positions of the breakpoints and investigate the relationship of the breakpoints, linewidth, and kinematic parameters, nine experiments with different combinations of nominal acceleration and nominal feed were conducted, as shown in the table in FIG. 27 (the jerk is a fixed value of 8 millimeters per second (mm/s)).

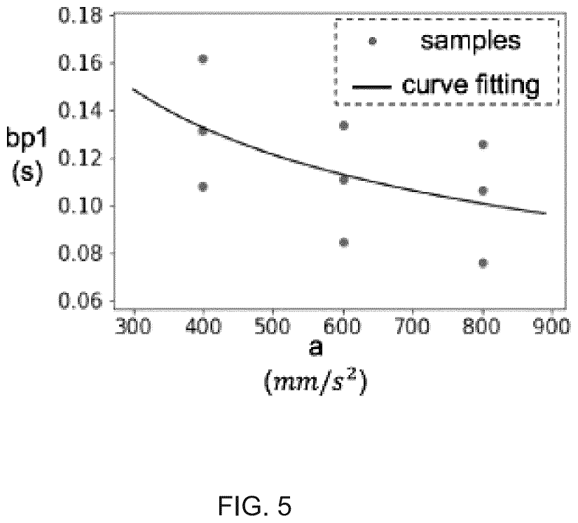

Based on the experiment results, the following conclusions on breakpoints can be drawn.
(1) Breakpoint 1 (bp1) is the point where linewidth reaches its minimum value and starts increasing. The time position of the point is related to the nozzle acceleration that is shown in FIG. 5.
(2) Breakpoint 2 (bp2) is the point where the acceleration phase stops.
(3) Breakpoint 3 (bp3) is the point where linewidth first reaches the nominal width.
(4) Breakpoint 4 (bp4) is the point where the nozzle starts decelerating.

According to the conclusions, bp2, bp3, bp4, and bp5 may be analytically determined by the nozzle motion state (i.e., analyzing the transition points of feed accelerate-constant-decelerate and the linewidth status, and/or inferring the time when reaches its nominal linewidth). However, bp1 may need to be decided based on nozzle acceleration. The following Equation (2) can be used to characterize the relationship between bp1 and acceleration with parameters c₀, C₁, and c₂:

bp1=c₀+cₐa^{c}^{₂} (2)

The fitted results are shown in FIG. 5. It is worth noting that other models may also describe the relationships between bp1 and acceleration and the use of this model is not intended to be limiting After deciding the breakpoints, the models for every phase (segmentations) may be as follows:

$$w ( t ) = \{ \begin{matrix}\frac{1}{\text{?} ( t ) + \text{?}} + \text{?} , & if 0 \leq t \leq bp 1 \\ β \sqrt{( t - bp 1 ) \text{?} ( t ) \text{?}} + w ( bp 1 ) + \text{?} , & if bp 1 < t \leq bp 2 \\ γ \sqrt{( t - bp 2 ) \text{?} ( t )} + w ( bp 2 ) + \text{?} , & if bp 2 < t \leq bp 3 \\ c + \text{?} , & if bp 3 < t \leq bp 4 \\ ρlog ( \frac{F}{\text{?} ( t )} ) + w ( bp 4 ) + \text{?} , & if bp 4 < t\end{matrix} \qquad ( 3 )$$

$$\text{?} \text{indicates text missing or illegible when filed}$$

where w(t) is the linewidth at printing time t, v(t) represents the actual nozzle travel speed at time t, a and F are the actual acceleration and the actual target feed speed, respectively (calculated via (1), {a₁, a₂, β, γ, c, p} are unknown parameters, and {e₁, e₂, e₃, e₄, e₅} are independent and identically distributed random errors with the normal distribution of N˜(0, σ²).

Equation (3) is an empirical model based on the experiment results to simplify the model format. It is worth noting that the model in each piece may be a linear model in terms of the certain transformation of t, v(t), a, and F (e.g., (t−bp2)v(t)^{1/2} in segment, p3). In order to estimate the parameters {a₁, a₂, β, γ, c, p}, the maximum log-likelihood estimation or least-squares estimation may be employed for every phase. In order to simplify the model, {θᵢ}_{i=1 . . . 6} can be used to represent the six parameters {a1,a2,β,γ,c,ρ}. Thus, the format of the model can be written as w(t)=Xᵢθᵢ+wbpᵢ₋₁)+eᵢ, where eᵢ is a noise term, if bpᵢ₋₁<t≤bpᵢ.

As a summary, the model construction may include the following procedures.
(1) Conduct printing experiments with different specified acceleration and feed in G-code and measure the printing linewidth for data collection.
(2) Select a pair of values for rₐ and r_{F} from a specified grid as the example shown in step (1) to calculate the actual acceleration and target feed speed.
(3) Identify the breakpoints based on the linewidth measurements and the kinematic analysis (for example, by using the actual acceleration and target feed speed obtained in step (1)) of the nozzle.
(4) Decide the relationship of bp1-acceleration based on the identified bp1 data and the actual acceleration obtained in step (1) (i.e., estimate the parameters {c₀, c₁, c₂} of Equation (2)).
(5) Based on the identified breakpoints, partition the experimental data into five data sets.
(6) Train the piecewise model for every partitioned data sets (i.e., estimate the parameters {a₁, a₂, β, γ, c, p} of Equation (3)) and calculate the sum of fitting errors (for example, root-mean-square error (RMSE)).
(7) Try a different pair of values of rₐ and r_{y} and repeat the procedures above until exploring the possible pairs of candidate values of rₐ and r_{F} from the specified grid.
(8) Select the estimation of {rₐ, r_{F}}, {c₀, c₁, c₂} and {a₁, a₂, β, γ, c, p} that has the minimum fitting RMSE as the final optimal model estimation.

For the incoming/new printing processes, the linewidth prediction is made as follows:
(1) Calculate the actual acceleration and the actual target feed speed via Equation (1) using the estimated optimal {rₐ, r_{F}}.
(2) Calculate the bp1 using Equation (2) with the estimated optimal {c0, c1, c2}.
(3) Obtain the values of bp2 and bp4 through kinematic analysis.
(4) Make piecewise predictions using Equation (3) with the estimate optimal {a₁, a₂, β, γ, c, p}.
(5) Stop estimating p3 when it reaches the target printing linewidth. The cutoff point may be bp3.
(6) The final prediction is made by connecting p1, p2, p3, p4, and p5 together.

Special cases may include the following. First, the printing length might be too short for the nozzle to reach the target feed speed. The movement of the extruder will only have acceleration and deceleration phases, which makes the bp2 and bp4 overlap. In this case, the number of model partitions can be reduced, i.e., only p1, p2, and p5 may be considered. Second, the estimated value of bp1 is bigger than that of bp2, i.e., bp2 is in front of bp1. In this case, p2 may be ignored, simplifying (1) to a four-piece model.

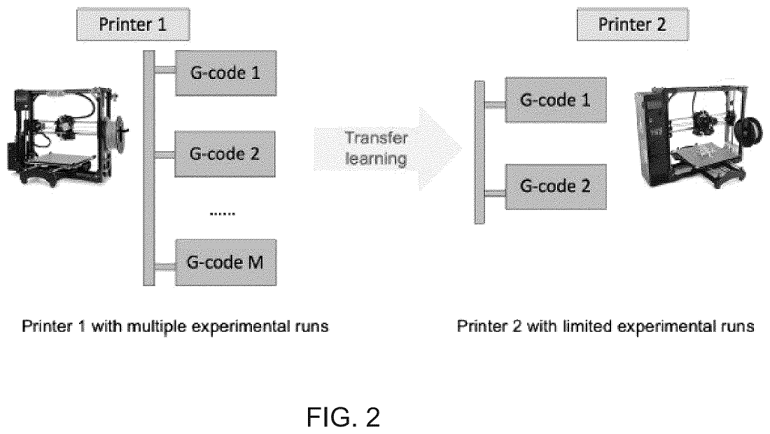

The primary purpose of developing the kinematics-quality model is to provide an engineering-driven method to characterize the between-printer relatedness for transfer learning. Traditional data-driven transfer learning usually adopts a high-level abstract data structure, such as kernels or common neural network layers, to capture the shared knowledge between different data sources. The data-driven approach has two disadvantages: (1) the between-printer relatedness lacks engineering interpretation; and (2) data-driven approaches usually involve a large number of hard-to-explain model para-meters, increasing the model complexity for learning. The engineering-driven model reveals the engineering mechanism regarding the similar impacts of kinematics effects on printed quality among multiple extrusion-based printers. The derived piecewise model is guided by kinematics and has a concise model structure with fewer model parameters, greatly facilitating transfer learning (see also, e.g., FIG. 2).

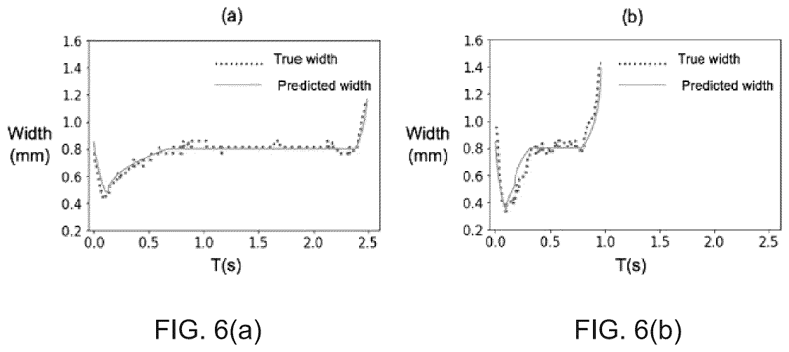

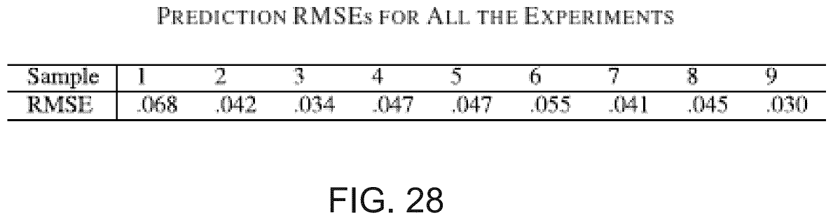

In order to test the performance of the model, the experiment data was split into the training and testing data (see also the table in FIG. 27). The split involves using eight experiment samples as the training data and the remaining one experiment sample as the testing data. This process is repeated nine times until each of all samples has been used as the testing data for once. The root mean square error (RMSE) was used as the metric to evaluate the prediction performance. The table in FIG. 28 summarizes the RMSE for all the nine cases. FIGS. 6(a) and 6(b) show the prediction results with the minimum and maximum RMSE. Based on the results, it can be concluded that the model can accurately capture the relationship between kinematic parameters and printing linewidth for quality prediction.

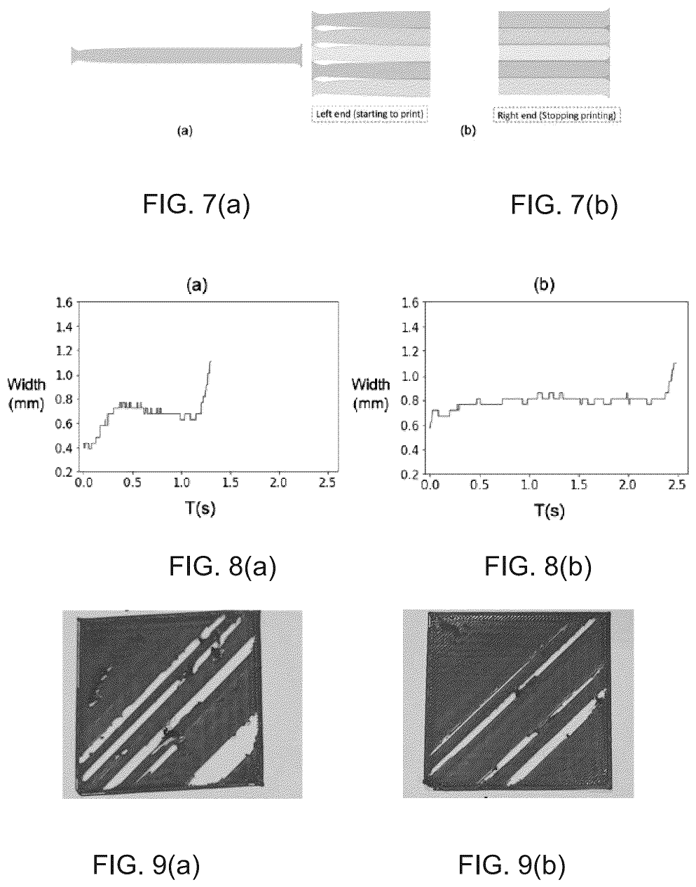

The printed lines are building elements for each layer in the printed structure. Although multiple printed lines often overlap to ensure the density of the printed block in some scenarios, the non-uniformity in the overlapped area still contributes to infill defects, mechanical strength problems, and surface height variation (surface shape and roughness). The infill non-uniformity can be estimated by applying the proposed model to multiple lines printed side-by-side. FIGS. 7(a) and 7(b) show the capability of the model estimating the printed material distribution non-uniformity. It can be seen that the model estimation can effectively capture the between-line gaps or void defects as well as non-uniform material overlap near the two ends of multiple infill lines.

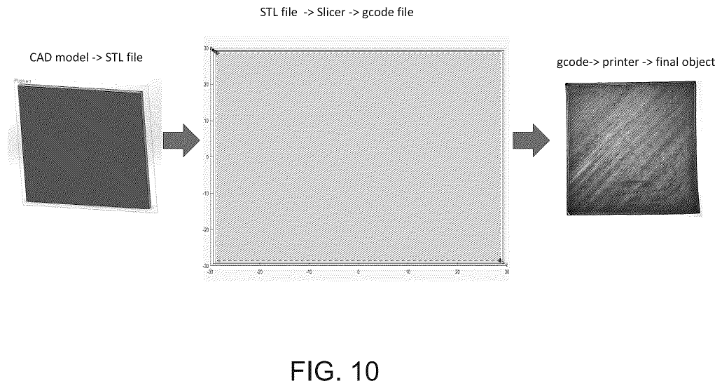

FIGS. 9(a) and 9(b) illustrate how different parameter settings (for example, temperature, speed, etc.) in G-code cause a significant impact on printing quality or cause bad quality. FIG. 10 shows a conventional 3D printing procedure. For example, FIG. 10 shows a G-code file including a G-code path (shown in the middle image). The G-code path may be the path that the nozzle of the 3D printer would follow as it prints material to generate the 3D object. The resulting 3D printed object is shown on the right in the figure.

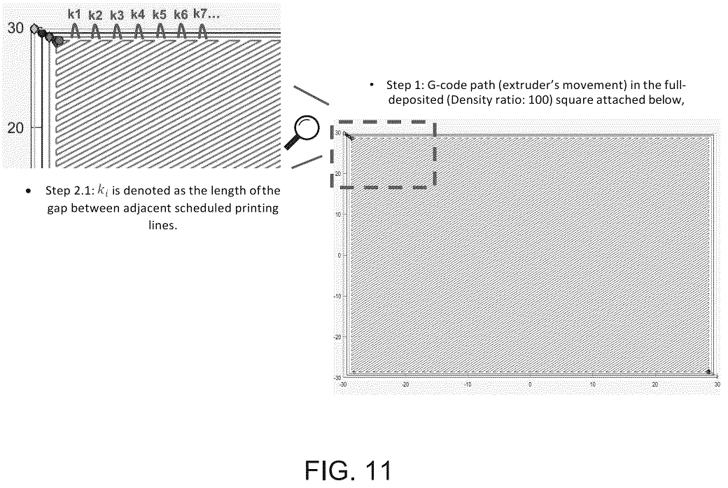

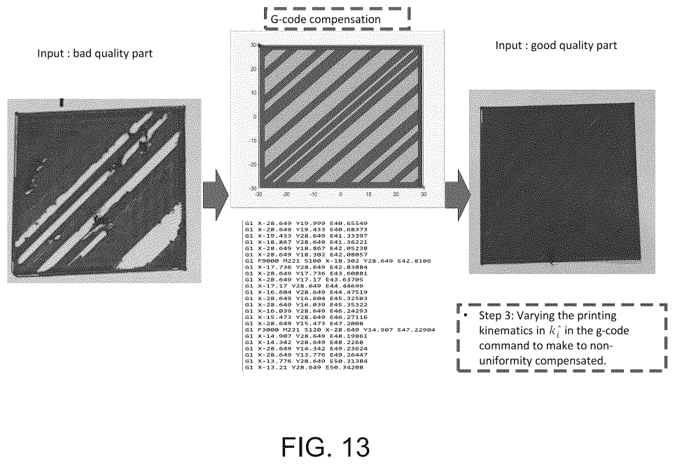

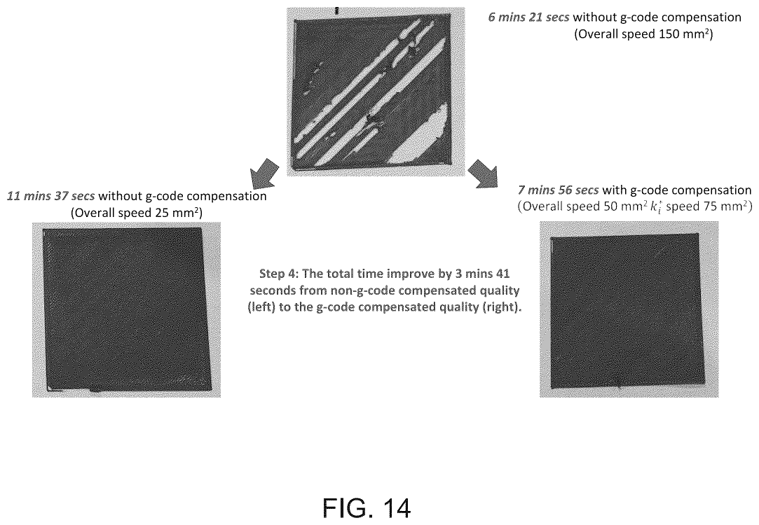

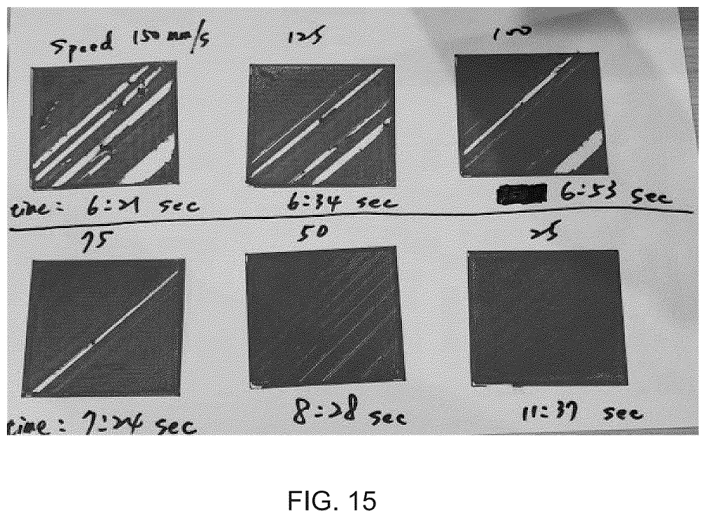

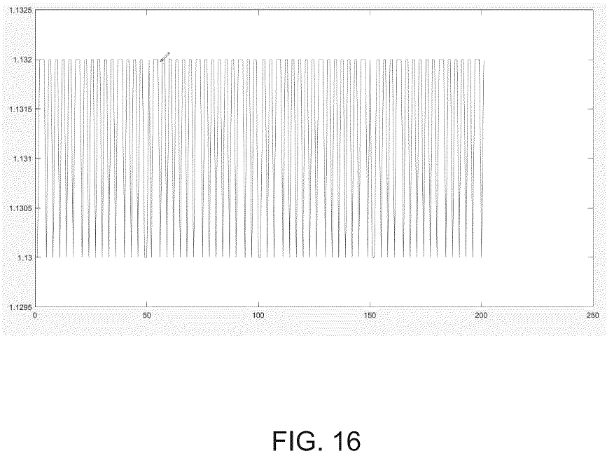

FIGS. 11-13 show one example approach for performing G-code compensation. Step 1: Obtain the G-code path of the printing part. Step 2: Detect the location of non-uniformities in the g-code file. Step 3: Adjust the extruder's kinematics (i.e., Speed) in the G-code path to compensate the local non-uniformities (under and over extrusion) Step 4: Evaluate the printing quality and time are improved. FIG. 13 also shows a comparison between a result of 3D printing without performing the G-code compensation and a result of 3D printing with performing the G-code compensation of embodiments of the subject invention.

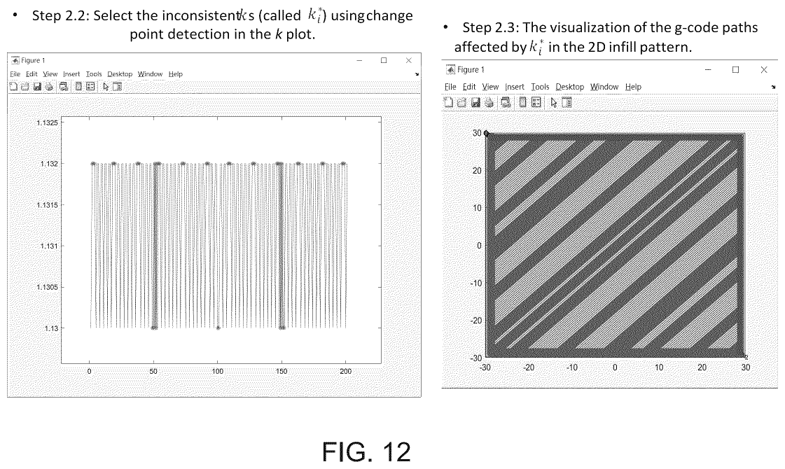

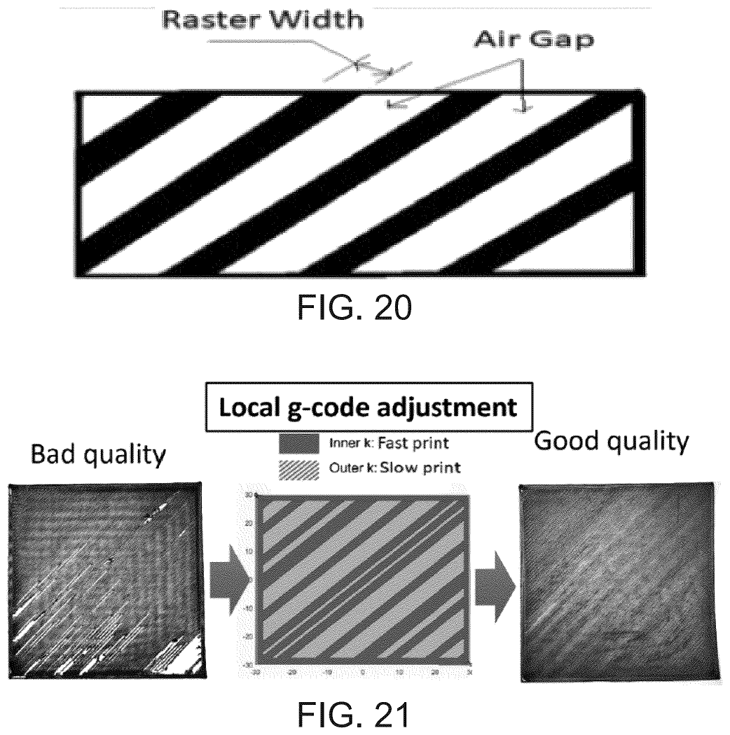

In some embodiments, step 2 may involve locating the “k” gaps in the G-code path and identifying inconsistencies in the gaps. The “k” values represent features or characteristics extracted from the geometric patterns of the planned paths generated by the 3D printer's existing software. That is, the different “k” values represent the length of the gaps between adjacent printing lines in the G-code. FIG. 20 shows a schematic view of air gaps on a 3D printed object. The “k” values may be represented in a plot (for example, shown in FIG. 12 on the left and in FIG. 16). By identifying singularity patterns (for example, shown on the right in FIG. 12), it may be determined where defects are more likely to happen at high printing speeds. For example, areas where the “k” is larger than the other “k” gaps, is larger than a threshold value, etc. may be identified. These areas where defects are likely to occur are illustrated through the red lines.

In these areas where it is determined that defects are likely to occur, the G-code may be adjusted to compensate for the material loss that causes the defects. For example, the 3D printer may be instructed to compensate for these areas of likely defect by slowing down and/or printing extra material in those regions. In other areas, the printing speed may remain high given the low likelihood of defects occurring. The impact of this is that the overall printing speed may be increased, while maintaining quality of the 3D-printed object.

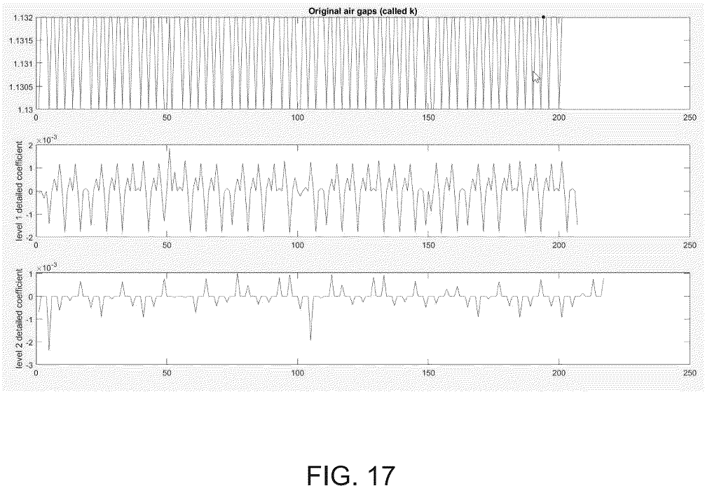

There may also be other ways to identify areas where printing quality is likely to be reduced. For example, analyzing the thickness of the lines included in the G-code pattern. FIG. 17 illustrates example plots associated with a wavelet analysis that may also be performed to identify the likely defect areas. The wavelet analysis may involve taking one or more derivatives of the original plot showing the “k” values (for example, FIG. 16). A plot representing a first derivative of FIG. 16 is shown as the second plot in FIG. 17, and a plot representing a second derivative of FIG. 16 is shown as the third plot in FIG. 17. The third plot in FIG. 17 shows one or more points where a magnitude of the plot is noticeably greater than other portion of the plot. These points may indicate areas where defect may be likely to occur.

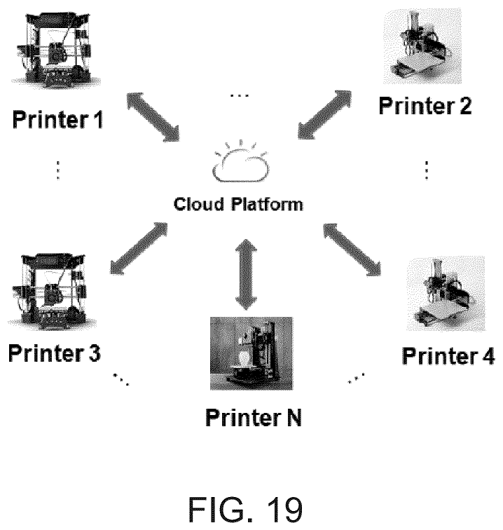

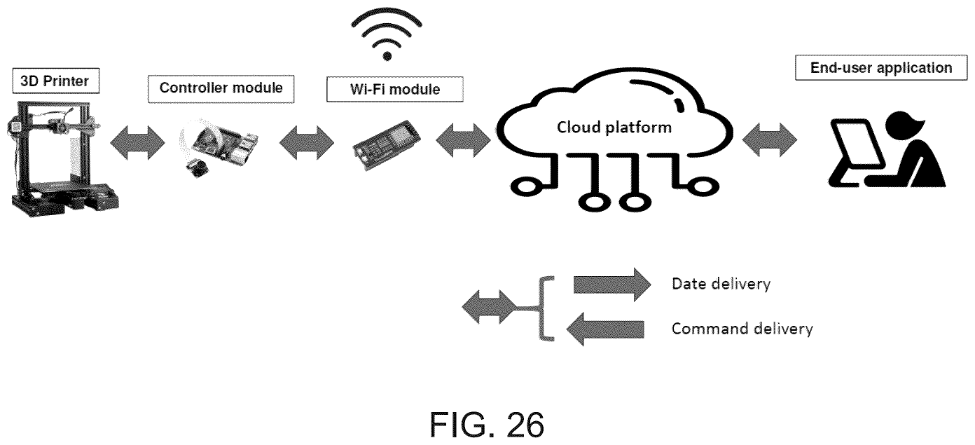

FIG. 19 shows a schematic view of interconnected printers over the cloud, according to an embodiment of the subject invention, and FIG. 26 shows a schematic view of a cloud-based platform, according to an embodiment of the subject invention. In certain embodiments a cloud-based platform can be utilized, as illustrated in one or both of these figures.

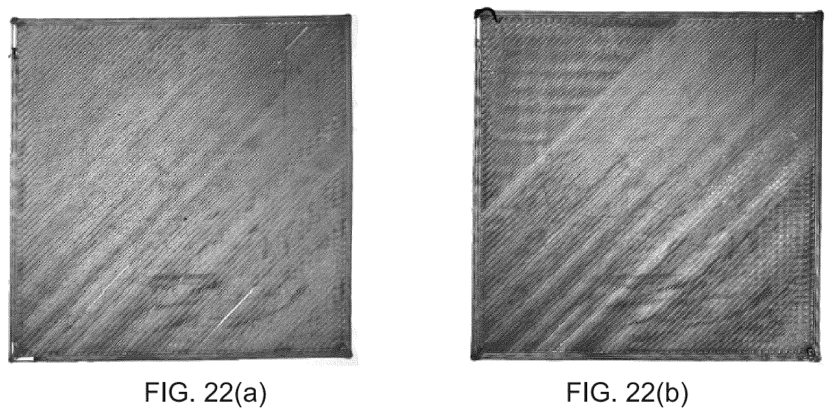

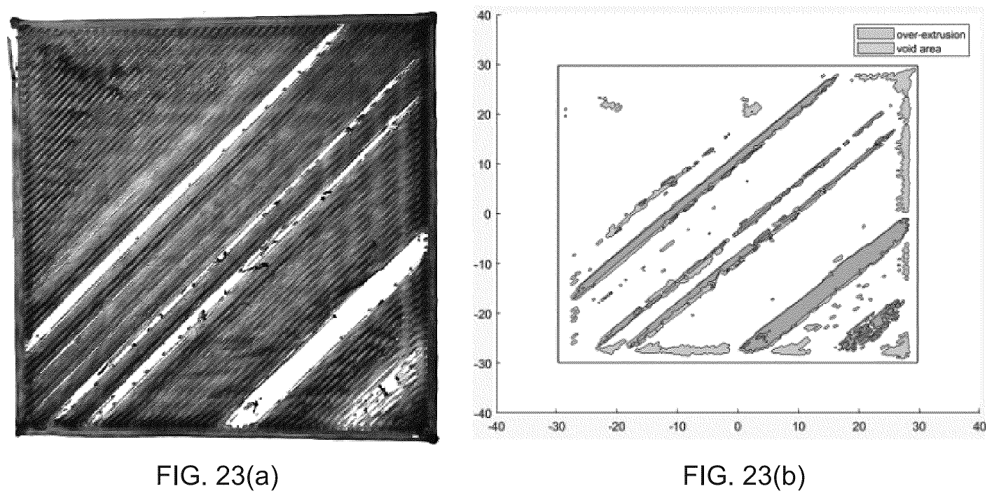

FIG. 21 shows a comparison of printing with and without local G-code compensation. FIG. 22(a) shows an image of a 3D printed object with overall G-code adjustment. The printing time was 11 minutes and 37 seconds, with an overall speed of 25 square millimeters per second (mm²/s). The inner k (air gap) was 75 square millimeters (mm²), and the outer k was 25 mm². FIG. 22(b) shows an image of a 3D printed object with G-code compensation strategy. The printing time was 7 minutes and 56 seconds, with an overall speed of 25 mm²/s. The inner k (air gap) was 75 square millimeters (mm²), and the outer k was 25 mm². FIG. 23(a) shows an image of non-uniformity on a two-dimensional (2D) printing part, and FIG. 23(b) shows an image segmentation using Matlab on the part in FIG. 23(a), where the image segmentation shows over-extrusion and void areas.

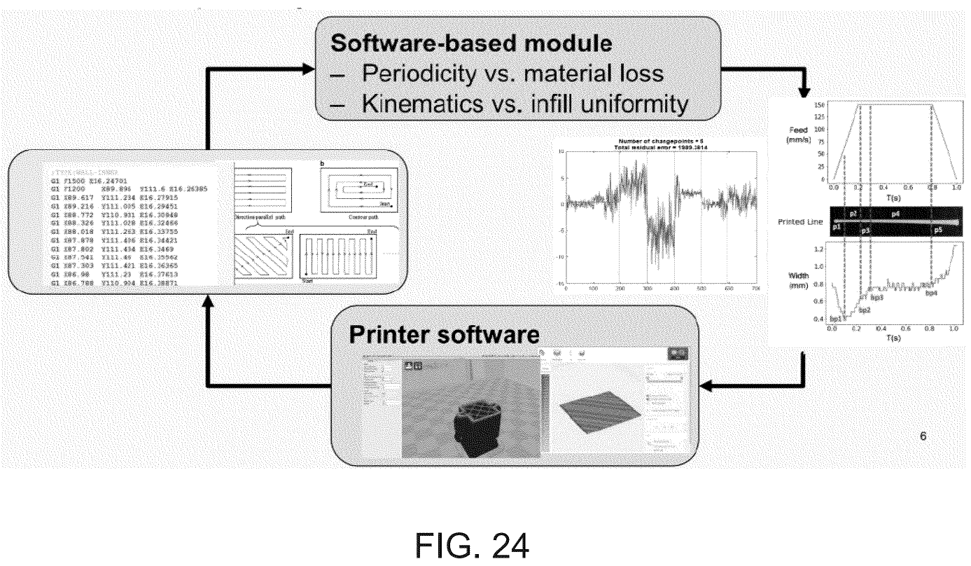

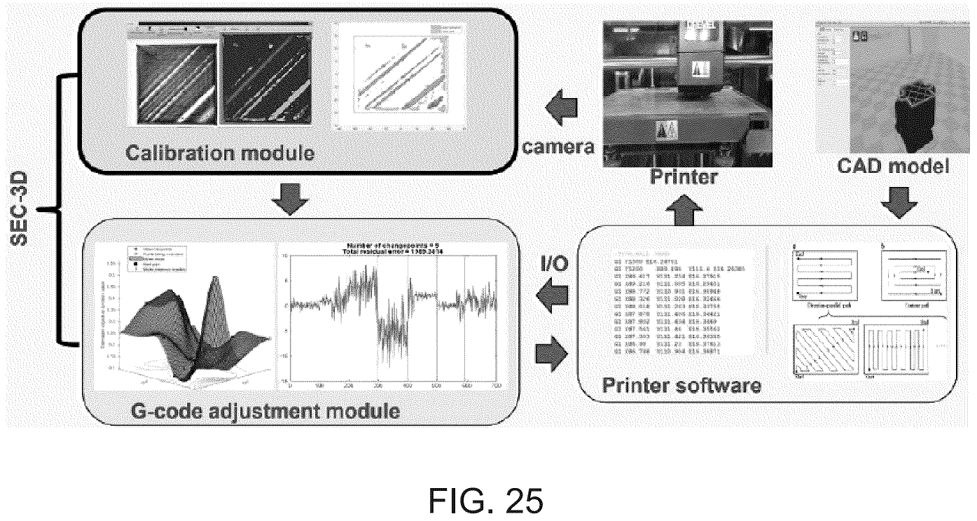

FIG. 24 shows a schematic view of a system and a process flow for error reduction in 3D printing, according to an embodiment of the subject invention. FIG. 25 shows a schematic view of a system for error reduction in 3D printing, according to an embodiment of the subject invention. Embodiments of the subject invention can include any or all of the features depicted in FIG. 24 and/or 25.

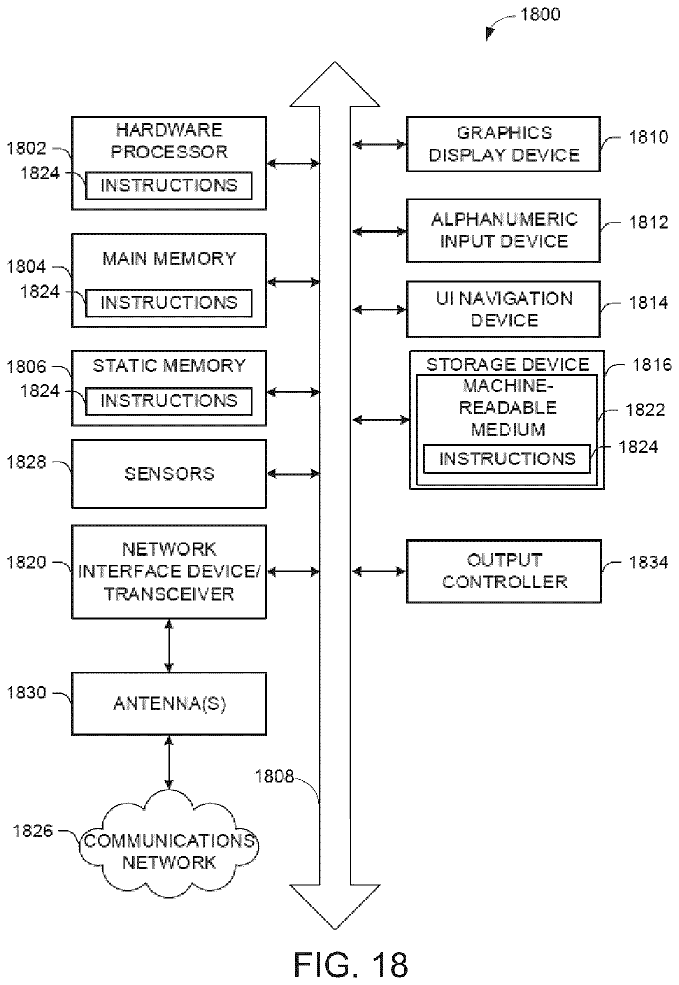

FIG. 18 shows a block diagram of an example machine 1800 upon which any of one or more techniques (e.g., methods) may be performed, in accordance with one or more embodiments of the subject invention. In certain embodiments, the machine 1800 may operate as a standalone device or may be connected (e.g., networked) to other machines. In a networked deployment, the machine 1800 may operate in the capacity of a server machine, a client machine, or both in server-client network environments. In an example, the machine 1800 may act as a peer machine in peer-to-peer (P2P) (or other distributed) network environments. The machine 1800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1800 may include a hardware processor 1802 (e.g., a central processing unit (CPU), a graphics processing unit (GPU), a hardware processor core, or any combination thereof), a main memory 1804, and a static memory 1806, some or all of which may communicate with each other via an interlink (e.g., bus) 1808. The machine 1800 may further include a graphics display device 1810, an alphanumeric input device 1812 (e.g., a keyboard), and a user interface (UI) navigation device 1814 (e.g., a mouse). In an example, the graphics display device 1810, alphanumeric input device 1812, and UI navigation device 1814 may be a touch screen display. The machine 1800 may additionally include a storage device (i.e., drive unit) 1816, a network interface device/transceiver 1820 coupled to antenna(s) 1830, and one or more sensors 1828, such as a global positioning system (GPS) sensor, a compass, an accelerometer, or other sensor. The machine 1800 may include an output controller 1834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 1816 may include a machine readable medium 1822 on which is stored one or more sets of data structures or instructions 1824 (e.g., software) embodying or utilized by any one or more of the techniques or functions described herein. The instructions 1824 may also reside, completely or at least partially, within the main memory 1804, within the static memory 1806, or within the hardware processor 1802 during execution thereof by the machine 1800. In an example, one or any combination of the hardware processor 1802, the main memory 1804, the static memory 1806, or the storage device 1816 may constitute machine-readable media.

While the machine-readable medium 1822 is illustrated as a single medium, the term “machine-readable medium” may include a single medium or multiple media (e.g., a centralized or distributed database, and/or associated caches and servers) configured to store the one or more instructions 1824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1800 and that cause the machine 1800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1824 may further be transmitted or received over a communications network 1826 using a transmission medium via the network interface device/transceiver 1820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1820 may include one or more physical jacks (e.g., Ethernet, coaxial, or phone jacks) or one or more antennas to connect to the communications network 1826. In an example, the network interface device/transceiver 1820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1800 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

What has been described herein in the present specification and annexed drawings includes examples of systems, devices, techniques, and computer program products that, individually and in combination, certain systems and methods. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When ranges are used herein, combinations and subcombinations of ranges (e.g., subranges within the disclosed range), as well as specific embodiments therein, are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A system for error reduction in three-dimensional (3D) printing, the system comprising:
a processor; and
a machine-readable medium in operable communication with the processor and having instructions thereon that, when executed, perform the following steps:
receiving printer data indicative of a 3D object to be printed by a 3D printer;
identifying, based on the printer data, at least one printing defect area; and
adjusting at least one printing parameter in the printer data to compensate for the at least one printing defect area.

2. The system according to claim 1, wherein the at least one adjusted printing parameter is at least one of printing speed of the 3D printer, extrusion rate of the 3D printer, and linewidth of the 3D printer.

3. The system according to claim 1, wherein the printer data is G-code data for the 3D printer.

4. The system according to claim 1, wherein identifying the at least one printing defect area comprises determining the at least one printing defect area based on where a gap between adjacent portions of a 3D printing path is greater than a threshold value.

5. The system according to claim 1, wherein the instructions when executed further perform the step of providing to the 3D printer the printer data with the at least one adjusted printing parameter.

6. The system according to claim 1, wherein the printer data comprises a G-code path of the 3D printer,
wherein the identifying of the at least one printing defect area comprises detecting a location of non-uniformities in the printer data, and
wherein the adjusting of the at least one printing parameter to compensate for the at least one printing defect area comprises adjusting kinematics of an extruder of the 3D printer in the G-code path to compensate for the non-uniformities.

7. The system according to claim 6, wherein the instructions when executed further perform the step of providing to the 3D printer the printer data with the at least one adjusted printing parameter.

8. The system according to claim 7, wherein the instructions when executed further perform the step of evaluating a quality and time of printing that was performed by the 3D printer based on the printer data with the at least one adjusted printing parameter.

9. The system according to claim 6, wherein the non-uniformities in the printer data comprise under-extrusion and over-extrusion.

10. The system according to claim 6, wherein the non-uniformities in the printer data comprise gaps between adjacent printing lines.

11. A method for error reduction in three-dimensional (3D) printing, the method comprising:
receiving printer data indicative of a 3D object to be printed by a 3D printer;
identifying, based on the printer data, at least one printing defect area; and
adjusting at least one printing parameter in the printer data to compensate for the at least one printing defect area.

12. The method according to claim 11, wherein the at least one adjusted printing parameter is at least one of printing speed of the 3D printer, extrusion rate of the 3D printer, and linewidth of the 3D printer.

13. The method according to claim 11, wherein the printer data is G-code data for the 3D printer.

14. The method according to claim 11, wherein identifying the at least one printing defect area comprises determining the at least one printing defect area based on where a gap between adjacent portions of a 3D printing path is greater than a threshold value.

15. The method according to claim 11, further comprising providing to the 3D printer the printer data with the at least one adjusted printing parameter.

16. The method according to claim 11, wherein the printer data comprises a G-code path of the 3D printer,
wherein the identifying of the at least one printing defect area comprises detecting a location of non-uniformities in the printer data, and
wherein the adjusting of the at least one printing parameter to compensate for the at least one printing defect area comprises adjusting kinematics of an extruder of the 3D printer in the G-code path to compensate for the non-uniformities.

17. The method according to claim 16, further comprising providing to the 3D printer the printer data with the at least one adjusted printing parameter.

18. The method according to claim 17, further comprising evaluating a quality and time of printing that was performed by the 3D printer based on the printer data with the at least one adjusted printing parameter.

19. The method according to claim 16, wherein the non-uniformities in the printer data comprise at least one of under-extrusion, over-extrusion, and gaps between adjacent printing lines.

20. A system for error reduction in three-dimensional (3D) printing, the system comprising:
a 3D printer;
a processor in operable communication with the 3D printer; and
a machine-readable medium in operable communication with the processor and having instructions thereon that, when executed, perform the following steps:
receiving printer data indicative of a 3D object to be printed by the 3D printer;
identifying, based on the printer data, at least one printing defect area;
adjusting at least one printing parameter in the printer data to compensate for the at least one printing defect area; and
providing to the 3D printer the printer data with the at least one adjusted printing parameter,
wherein the at least one adjusted printing parameter is at least one of printing speed of the 3D printer, extrusion rate of the 3D printer, and linewidth of the 3D printer,
wherein the printer data is G-code data for the 3D printer,
wherein the G-code data for the 3D printer comprises a G-code path of the 3D printer,
wherein the identifying of the at least one printing defect area comprises detecting a location of non-uniformities in the printer data,
wherein the adjusting of the at least one printing parameter to compensate for the at least one printing defect area comprises adjusting kinematics of an extruder of the 3D printer in the G-code path to compensate for the non-uniformities, and
wherein the non-uniformities in the printer data comprise at least one of under-extrusion, over-extrusion, and gaps between adjacent printing lines.
